(19) United States
(12) Patent Application Publication
(10) Pub. No.: US 2010/0156742 A1
(43) Pub. Date: Jun. 24, 2010

(54) ANTENNA DEVICE

(75) Inventors: Masahiro Yanagi, Shinagawa (JP); Shigemi Kurashima, Shinagawa (JP); Takashi Arita, Shinagawa (JP)

Correspondence Address: IPUSA, P.L.L.C, 1054 31ST STREET, N.W., Suite 400, Washington, DC, 20007, US

(73) Assignee: FUJITSU COMPONENT LIMITED

(21) Appl. No.: 12/575,527

(22) Filed: Oct. 8, 2009

(30) Foreign Application Priority Data
Dec. 24, 2008 (JP) 2008-328199

(51) Int. Cl. H01Q 1/36; H01Q 1/48; H01Q 1/40

(52) U.S. Cl. 343/846; 343/873; 343/899

(57) ABSTRACT

An antenna device includes a teardrop-shaped element including a cone-shaped part and a spherical surface part geometrically combined so that the spherical surface part is in contact with the cone-shaped part on its bottom-surface side; a ground plate opposed to the apex of the cone-shaped part of the teardrop-shaped element; and a coaxial line having an inside conductor connected to the apex of the cone-shaped part of the teardrop-shaped element and having an outside conductor connected to the ground plate. The ground plate defines a surface of a metal enclosure of a device to be connected to the antenna device, the device having at least one of a transmission function and a reception function.

### CROSS-REFERENCE TO RELATED APPLICATION

The present application is based upon and claims the benefit of priority of Japanese Patent Application No. 2008-328199, filed on Dec. 24, 2008, the entire contents of which are incorporated herein by reference.

### BACKGROUND OF THE INVENTION

1. Field of the Invention

The present invention relates to an antenna device used in apparatuses having the function of receiving or transmitting radio waves.

2. Description of the Related Art

In recent years, radio communication technologies using UWB (Ultra Wideband), which enables radar positioning and communications at high data transfer rates, have attracted attention. Since 2002, UWB has been approved for use in a frequency band of 3.1 GHz to 10.6 GHz by the U.S. FCC (Federal Communications Commission).

UWB systems perform communication by transmitting pulse signals across a wide frequency band. Accordingly, it is desired that antennas used for UWB have such a structure as to enable transmission and/or reception across a wideband.

Patent Document 1 and Non-Patent Document 1 listed below describe antennas formed of a ground plate and a feeding body as antennas for use in at least the FCC-approved 3.1-10.6 GHz frequency band.

FIGS. 1A and 1B are diagrams illustrating conventional antennas. FIG. 2 is a block diagram illustrating a conventional antenna device.

An antenna 10 illustrated in FIG. 1A includes a ground plate 11 and a feeding body 12 of an inverse cone shape placed on the ground plate 11.

The cone forming the feeding body 12 is provided so that its side surface is at an angle θ to the surface of the ground plate 11. Desired characteristics are obtained with this angle θ.

An antenna 20 illustrated in FIG. 1B includes the ground plate 11 and a teardrop-shaped feeding body 22 placed on the ground plate 11. The feeding body 22 includes a cone 22a and a sphere 22b inscribed on the cone 22a.

Referring to FIG. 2, the feeding bodies 12 and 22 of the antennas 10 and 20, respectively, are connected to a filter 31. The filter 31 extracts a component of a desired frequency band from a radio wave received with, for example, the feeding body 12. The component extracted by the filter 31 is provided to a transmission and reception unit 32. The transmission and reception unit 32 performs signal processing that serves as the pre-processing or post-processing of the received radio wave.

[Patent Document 1] Japanese Laid-Open Patent Application No. 2004-129209

[Non-Patent Document 1] Taniguchi, T. and Takehiko Kobayashi (Tokyo Denki University); An Omnidirectional and Low-VSWR Antenna for the FCC-approved UWB Frequency Band, Institute of Electronics, Information, and Communications Engineers, B-1-133, B201, Mar. 22, 2003

### SUMMARY OF THE INVENTION

According to an aspect of the present invention, an antenna device includes a teardrop-shaped element including a cone-shaped part and a spherical surface part geometrically combined so that the spherical surface part is in contact with the cone-shaped part on a bottom-surface side thereof; a ground plate opposed to an apex of the cone-shaped part of the teardrop-shaped element; and a coaxial line having an inside conductor thereof connected to the apex of the cone-shaped part of the teardrop-shaped element and having an outside conductor thereof connected to the ground plate, wherein the ground plate defines a surface of a metal enclosure of a device to be connected to the antenna device, the device having at least one of a transmission function and a reception function.

According to an aspect of the present invention, an antenna device includes a teardrop-shaped element including a cone-shaped part and a spherical surface part geometrically combined so that the spherical surface part is in contact with the cone-shaped part on a bottom-surface side thereof; a ground plate opposed to an apex of the cone-shaped part of the teardrop-shaped element; and a coaxial line having an inside conductor thereof connected to the apex of the cone-shaped part of the teardrop-shaped element and having an outside conductor thereof connected to the ground plate, wherein the ground plate is provided on one of an exterior surface and an interior surface of a metal enclosure of a device to be connected to the antenna device, the device having at least one of a transmission function and a reception function.

The object and advantages of the embodiments will be realized and attained by means of the elements and combinations particularly pointed out in the claims.

It is to be understood that both the foregoing general description and the following detailed description are exemplary and explanatory and not restrictive of the invention as claimed.

### BRIEF DESCRIPTION OF THE DRAWINGS

Other objects, features and advantages of the present invention will become more apparent from the following detailed description when read in conjunction with the accompanying drawings, in which:

FIGS. 1A and 1B are diagrams illustrating conventional antennas;

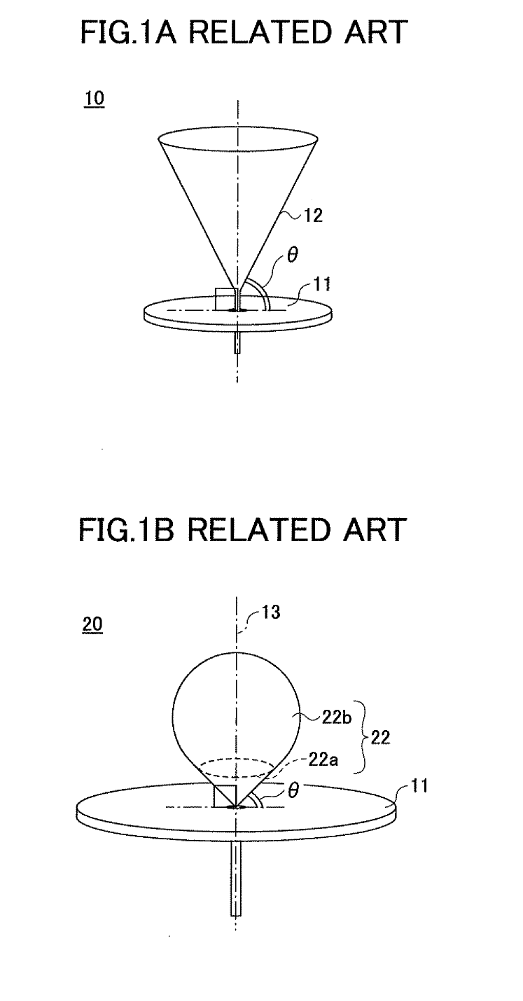

FIG. 2 is a block diagram illustrating a conventional antenna device;

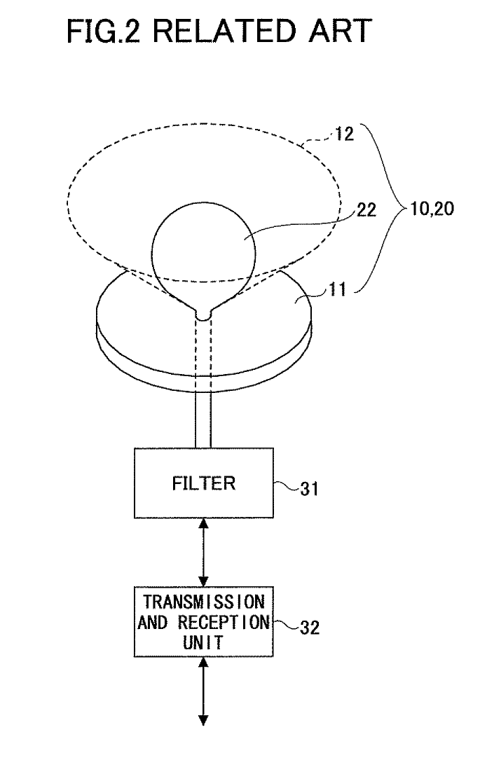

FIGS. 3A and 3B are diagrams illustrating an antenna device according to a first embodiment of the present invention;

FIG. 4 is a cross-sectional view of the antenna device according to the first embodiment of the present invention;

FIGS. 5A and 5B are diagrams illustrating another configuration of the antenna device according to the first embodiment of the present invention;

FIGS. 6A and 6B are diagrams illustrating yet another configuration of the antenna device according to the first embodiment of the present invention;

FIGS. 7A and 7B are diagrams illustrating yet another configuration of the antenna device according to the first embodiment of the present invention;

FIGS. 8A through 8C are diagrams illustrating an antenna device according to a second embodiment of the present invention;

FIGS. 9A through 9C are diagrams illustrating an antenna device according to a third embodiment of the present invention; and

FIGS. 10A through 10F are diagrams illustrating methods of attaching an antenna device according to the third embodiment of the present invention.

### DETAILED DESCRIPTION OF THE PREFERRED EMBODIMENTS

Such conventional structures as described above, where a cone-shaped or teardrop-shaped feeding body is connected to a ground plate, may be prevented from performing radio wave communications because of a change in the transmission or reception condition of radio waves due to movements or sideways rolls, thus having a problem in light of communications stability.

Further, a cable for connecting a transmission and reception unit and an antenna device causes an increase in cost.

Furthermore, antenna devices having a cone-shaped or teardrop-shaped feeding body provided on a ground plate have a structure where a projecting body is provided on the ground plate. Therefore, application of pressure to the feeding body causes deformation of the ground plate to change the positional relationship between the feeding body and the ground plate, thus causing a problem in that radio waves are not transmitted or received in optimum condition.

Moreover, there is also a demand for replaceability of the feeding body in accordance with an operating frequency band.

A description is given below, with reference to the accompanying drawings, of embodiments of the present invention.

### First Embodiment

According to a first embodiment of the present invention, there is disclosed an antenna device where a teardrop-shaped element is provided using an enclosure (case or housing) or its metal plate as a ground plate.

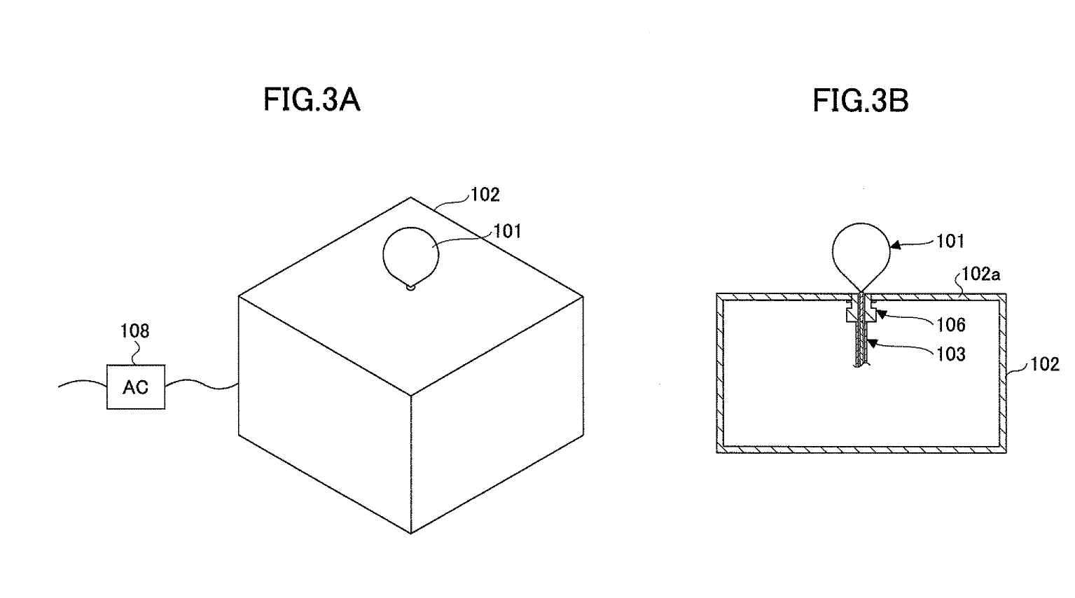

FIGS. 3A and 3B illustrate a configuration of an antenna device according to this embodiment. FIG. 3A is a perspective view of the antenna device, and FIG. 3B is a schematic diagram illustrating the inside of the antenna device.

The antenna device according to this embodiment includes a teardrop-shaped element 101.

The teardrop-shaped element 101, which serves as the feeding body of the antenna device, is provided on an enclosure 102 of a device having the function of transmitting and/or receiving radio waves, which device is connected to AC power 108.

The teardrop-shaped element 101 includes a cone-shaped part and a sphere-shaped (spherical surface) part geometrically combined into a teardrop shape with the sphere-shaped part in contact with the cone-shaped part on its bottom-surface side.

The teardrop-shaped element 101 is connected to the enclosure 102 at the apex of the cone-shaped part. The enclosure 102, which is formed of a metal material, has a function as the ground plate of the antenna device according to this embodiment.

The antenna device further includes a coaxial cable 103. The coaxial cable 103 has an inside conductor connected to the apex of the cone-shaped part of the teardrop-shaped element 101 and an outside conductor connected to the enclosure 102 serving as a ground plate.

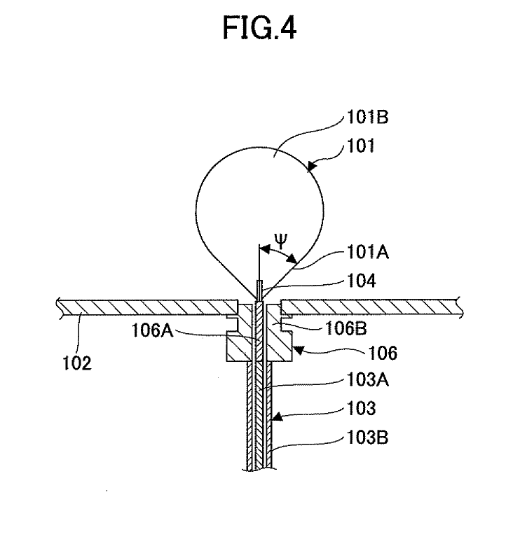

A more detailed description is given, with reference to FIG. 4, of the teardrop-shaped element 101 and the enclosure 102 serving as a ground plate according to this embodiment.

Referring to FIG. 4, the teardrop-shaped element 101 includes a cone-shaped part 101A and a sphere-shaped part 101B. The cone-shaped part 101A and the sphere-shaped part 101B are geometrically combined so that the sphere-shaped part 101B is in contact with the cone-shaped part 101A on its bottom-surface side. The cone-shaped part 101A is formed so as to have a predetermined half apical angle Ψ.

The antenna device includes a connector 106. The connector 106 includes an inside metal part 106A and an outside metal part 106B, which are insulated from each other. The connector 106 is attached to the enclosure 102. The connector 106 may be integrated with the enclosure 102 into a unitary structure.

The teardrop-shaped element 101 is vertically attached on one side (surface) of the enclosure 102 (in an insulated manner) at the apex of the cone-shaped part 101A. For example, an external thread part 104 is formed at the end of the inside metal part 106A of the connector 106 of the enclosure 102, and a corresponding internal thread part (not graphically illustrated) is formed at the apex of the cone-shaped part 101A, so that the teardrop-part 101 is screwed to the enclosure 102 through the external thread part 104 and the internal thread part. This configuration also allows the teardrop-shaped part 101 to be unscrewed from the enclosure 102.

Each of the teardrop-shaped part 101 and the enclosure 102 is formed of a metal material such as aluminum to be electrically conductive.

The coaxial cable 103 includes an inside conductor 103A and an outside conductor 103B. The coaxial cable 103 is connected to the connector so that the inside conductor 103A is electrically connected to the teardrop-shaped element 101 through the inside metal part 106A, the external thread part 104, and the internal thread part (not graphically illustrated).

The outside conductor 103B is electrically connected to the enclosure 102 that serves as a ground plate through the outside metal part 106B. The enclosure 102 is grounded through the outside metal part 106B of the connector 106 and the outside conductor 103B of the coaxial cable.

Thus, using one side or a top plate part 102a of the enclosure 102 as a ground plate eliminates the necessity of a separate ground plate and a cable for connecting the teardrop-shaped element 101 and the enclosure 102, thus making it possible to reduce cost. Further, since the teardrop-shaped element 101 is directly attachable to the enclosure 102, the teardrop-shaped element 101 is unlikely to move or roll sideways, so that it is possible to transmit and/or receive radio waves with stability.

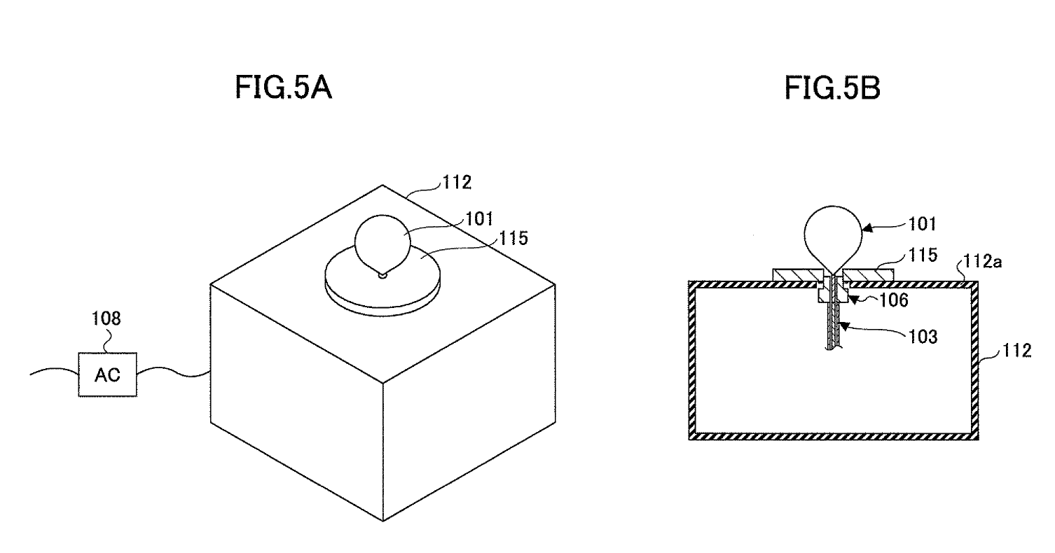

Next, FIGS. 5A and 5B illustrate another configuration of the antenna device according to this embodiment. FIG. 5A is a perspective view of the antenna device, and FIG. 5B is a schematic diagram illustrating the inside of the antenna device. In FIGS. 5A and 5B, the same elements as those described above are referred to by the same reference numerals, and a description thereof is omitted.

Referring to FIGS. 5A and 5B, the antenna device includes the teardrop-shaped element 101, the coaxial cable 103, the connector 106, and a metal plate 115.

In such a case as illustrated in FIGS. 5A and 5B, where an enclosure 112 of a device having the function of transmitting and/or receiving radio waves, which device is connected to the AC power 108, is formed of a non-conductive material such as a resin material, the antenna device may be configured so that the metal plate 115 is formed on a surface of the enclosure 112 (the exterior surface of a top plate part 112a of the enclosure 112); the connector 106 is attached to the metal plate 115; and the teardrop-shaped element 101 is attached to the enclosure 112 (through the metal plate 115 and the connector 106) using this metal plate 115 as a ground plate.

The coaxial cable 103 has the inside conductor 103A (FIG. 4) connected to the teardrop-shaped element 101 through the inside metal part 106A (FIG. 4) of the connector 106 and has the outside conductor 103B (FIG. 4) connected to the metal plate 115 through the outside metal part 106B (FIG. 4) of the connector 106.

In this case as well, a cable for connecting the enclosure 112 and the teardrop-shaped element 101 is unnecessary, so that it is possible to reduce cost. Further, it is possible to transmit and/or receive radio waves with stability.

The metal plate 115 may be provided as described above also in the case where the enclosure 112 is formed of a material such as metal, in order for the enclosure 112 to fully function as a ground plate.

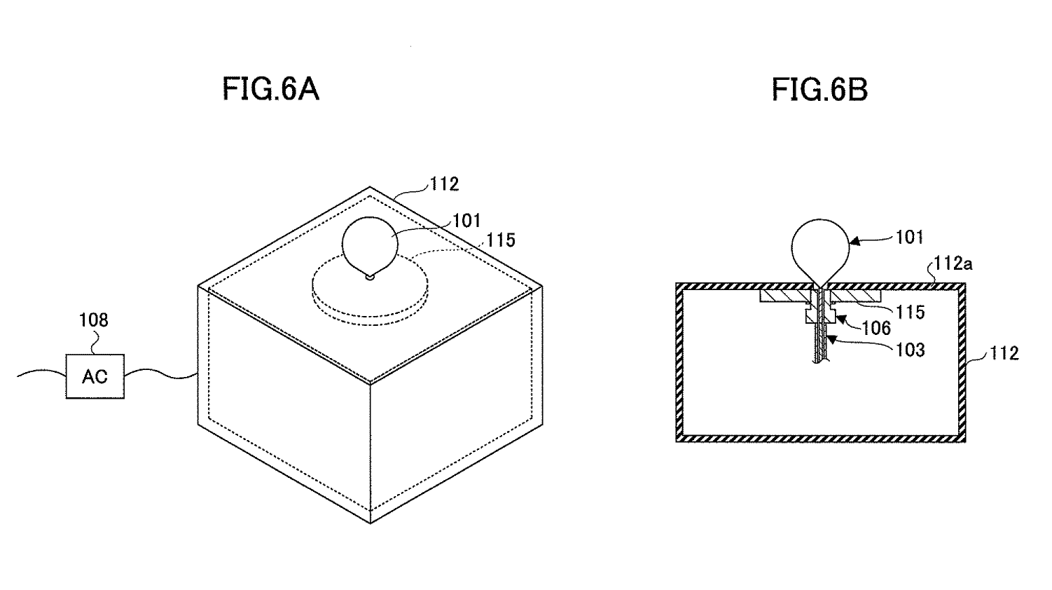

FIGS. 6A and 6B illustrate yet another configuration of the antenna device according to this embodiment. FIG. 6A is a perspective view of the antenna device, and FIG. 6B is a schematic diagram illustrating the inside of the antenna device. In FIGS. 6A and 6B, the same elements as those described above are referred to by the same reference numerals, and a description thereof is omitted.

As illustrated in FIGS. 6A and 6B, the metal plate 115 may be provided inside the enclosure 112. In the illustrated case, the metal plate 115 is provided on the interior surface of the top plate part 112a of the enclosure 112. That is, the teardrop-shaped element 101 is provided on the exterior side of the top plate part 112a and the metal plate 115 is provided on the other side (interior side) of the top plate part 112a. The same effects as described above are produced with this configuration.

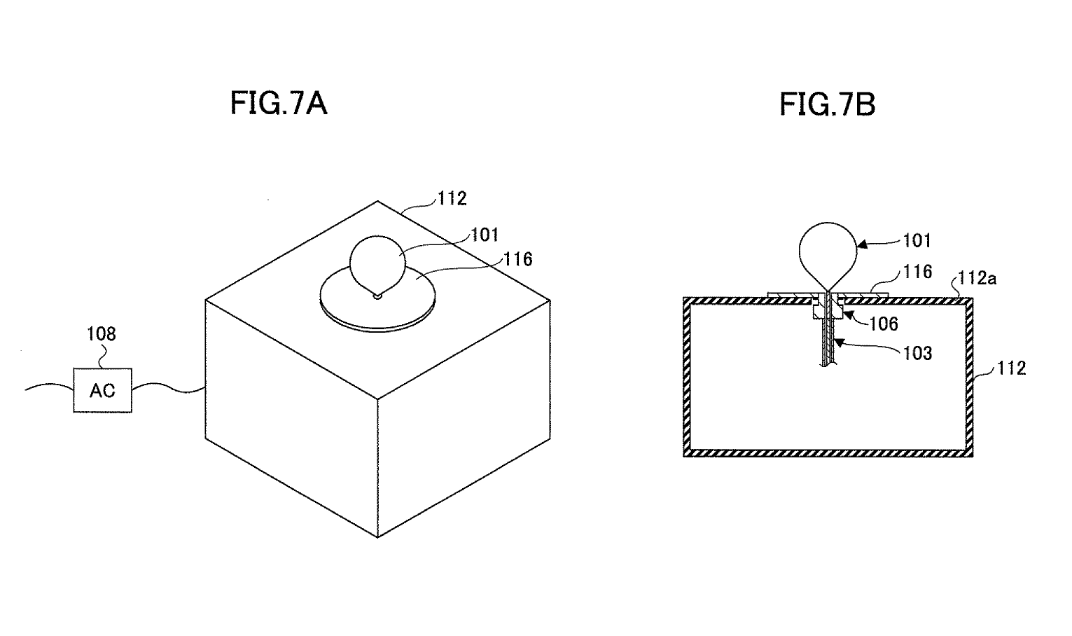

FIGS. 7A and 7B illustrate yet another configuration of the antenna device according to this embodiment. FIG. 7A is a perspective view of the antenna device, and FIG. 7B is a schematic diagram illustrating the inside of the antenna device. In FIGS. 7A and 7B, the same elements as those described above are referred to by the same reference numerals, and a description thereof is omitted.

Referring to FIGS. 7A and 7B, the antenna device includes the teardrop-shaped element 101, the coaxial cable 103, and a metal film 116. As illustrated in FIGS. 7A and 7B, the metal film 116 may be provided on a surface of the enclosure 112 (the exterior surface of the top plate part 112a) by metal plating.

The metal plate 115 illustrated in FIGS. 5A and 5B and FIGS. 6A and 6B and the metal plate 116 illustrated in FIGS. 7A and 7B are also grounded through the outside conductor 103B (FIG. 4) of the coaxial cable 103.

### Second Embodiment

A description is given of a second embodiment of the present invention.

According to the second embodiment, an antenna device is disclosed where a teardrop-shaped element is covered with resin.

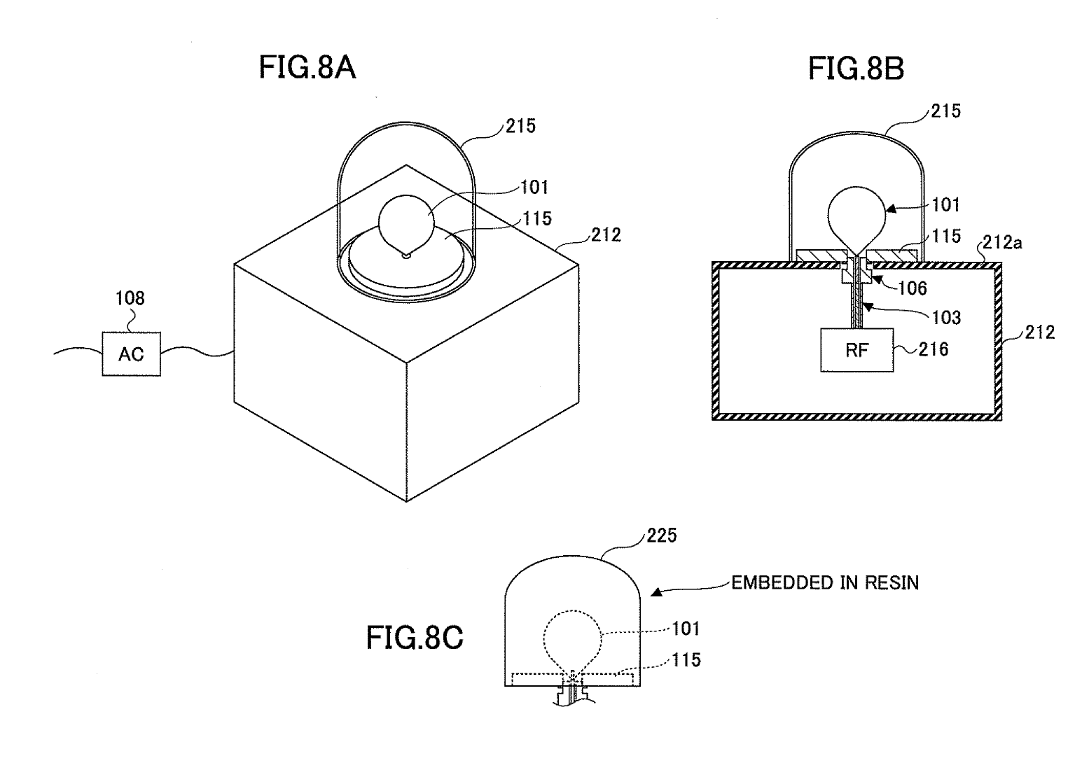

FIGS. 8A, 8B, and 8C illustrate a configuration of an antenna device according to this embodiment. FIG. 8A is a perspective view of the antenna device, and FIG. 8B is a schematic diagram illustrating the inside of the antenna device. In FIGS. 8A through 8C, the same elements as those described above are referred to by the same reference numerals, and a description thereof is omitted.

The antenna device according to this embodiment includes the teardrop-shaped element 101, the coaxial cable 103, the connector 106, the metal plate 115, and a resin cover 215.

The metal plate 115, which serves as a ground plate, is provided on the exterior surface of a top plate part 212a of an enclosure 212 of a device having the function of transmitting and/or receiving radio waves.

The enclosure 212 is formed of a non-conductive material such as a resin material. Alternatively, the enclosure 212 may be formed of an electrically conductive material such as metal.

The teardrop-shaped element 101 is attached to the enclosure 212 (through the metal plate 115 and the connector 106). The resin cover 215 is provided so as to cover the entire teardrop-shaped element 101.

Referring to FIG. 4 as well, the teardrop-shaped element 101 and the metal plate 115 are connected to the inside conductor 103A (through the inside metal part 106A) and the outside conductor 103B (through the outside metal part 106B), respectively, of the coaxial cable 103, which is connected to an RF terminal 216.

By thus providing the resin cover 215, the teardrop-shaped element 101 attached to the enclosure 212 is stabilized. As a result, even if an external force is applied, no change is caused in the positional relationship between the teardrop-shaped element 101 and the metal plate 115 serving as a ground plate, thus exerting no adverse effect on transmission or reception of radio waves. Since the resin material of the resin cover 215 is not electrically conductive, covering the entire teardrop-shaped element 101 with the resin cover 215 does not affect transmission or reception of radio waves.

Further, forming the resin cover 215 of a transparent resin material makes it possible to call attention to the teardrop-shaped element 101 inside the resin cover 215 because the teardrop-shaped element 101 can be seen through the resin cover 215.

Further, as illustrated in FIG. 8C, the entire teardrop-shaped element 101 may be embedded in a resin material 225. This makes it possible to fix the positional relationship between the teardrop-shaped element 101 and the metal plate 115 serving as a ground plate, so that it is possible to transmit and/or receive radio waves with stability. In this case as well, using a transparent resin material as the resin material 225 makes it possible to call attention to the teardrop-shaped element 101 inside the resin material 225 because the teardrop-shaped element 101 can be seen through the resin material 225. Since the resin material 225 used for embedding the teardrop-shaped element 101 has no electrical conductivity, embedding the entire teardrop-shaped element 101 in the resin material 225 does not affect transmission or reception of radio waves.

### Third Embodiment

A description is given of a third embodiment of the present invention.

According to this embodiment, there is disclosed an antenna device where a teardrop-shaped element is replaceable.

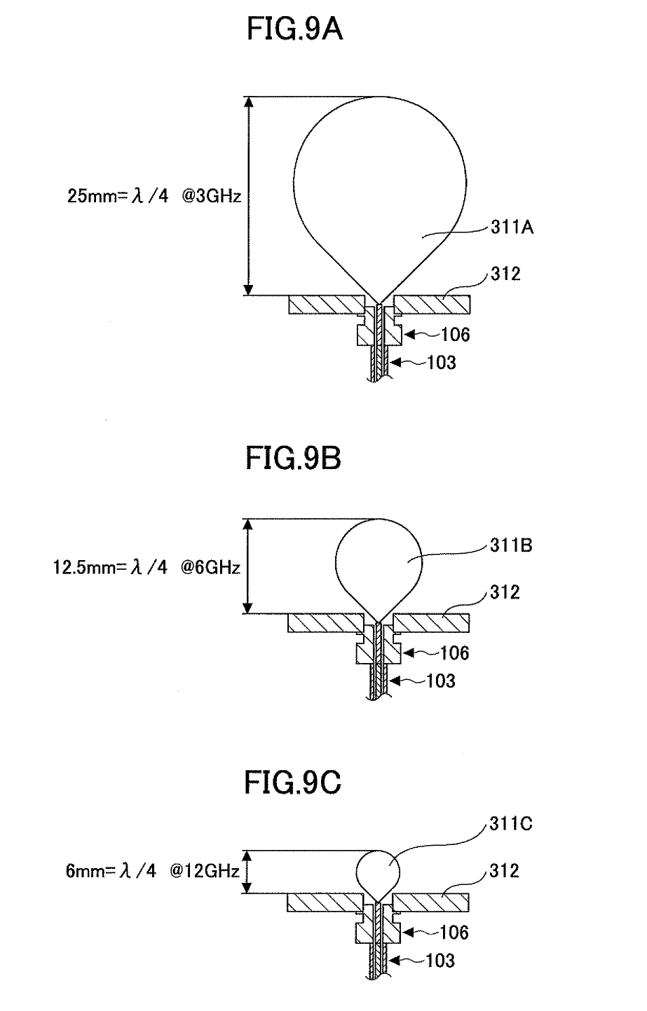

For example, as illustrated in FIGS. 9A through 9C, teardrop-shaped elements 311A, 311B, and 311C having different shapes may be used in accordance with operating frequency bands (frequency bands to be used). According to this embodiment, an antenna device is configured so that a teardrop-shaped element is replaceable with one corresponding to an operating frequency band.

The teardrop-shaped element 311A illustrated in FIG. 9A corresponds to the 3 GHz band, and has a height of approximately 25 mm, which corresponds to approximately λ/4 of the operating frequency band. This teardrop-shaped element 311A is attached mechanically (that is, through the connector 106) to a metal plate 312 provided in or on the enclosure (not graphically illustrated) of a device having the function of transmitting and/or receiving radio waves. If the enclosure is formed of a metal material, part of the enclosure may be used as a ground plate.

The teardrop-shaped element 311B illustrated in FIG. 9B corresponds to the 6 GHz band, and is approximately 12.5 mm in height. The teardrop-shaped element 311C illustrated in FIG. 9C corresponds to the 12 GHz band, and is approximately 6 mm in height. Their heights correspond to λ/4 of the respective operating frequency bands. Thus, the teardrop-shaped element to be used differs in shape from operating frequency band to operating frequency band. Therefore, the transmission and/or reception of radio waves is optimized by replacing the teardrop-shaped element in accordance with a frequency (band) to be used.

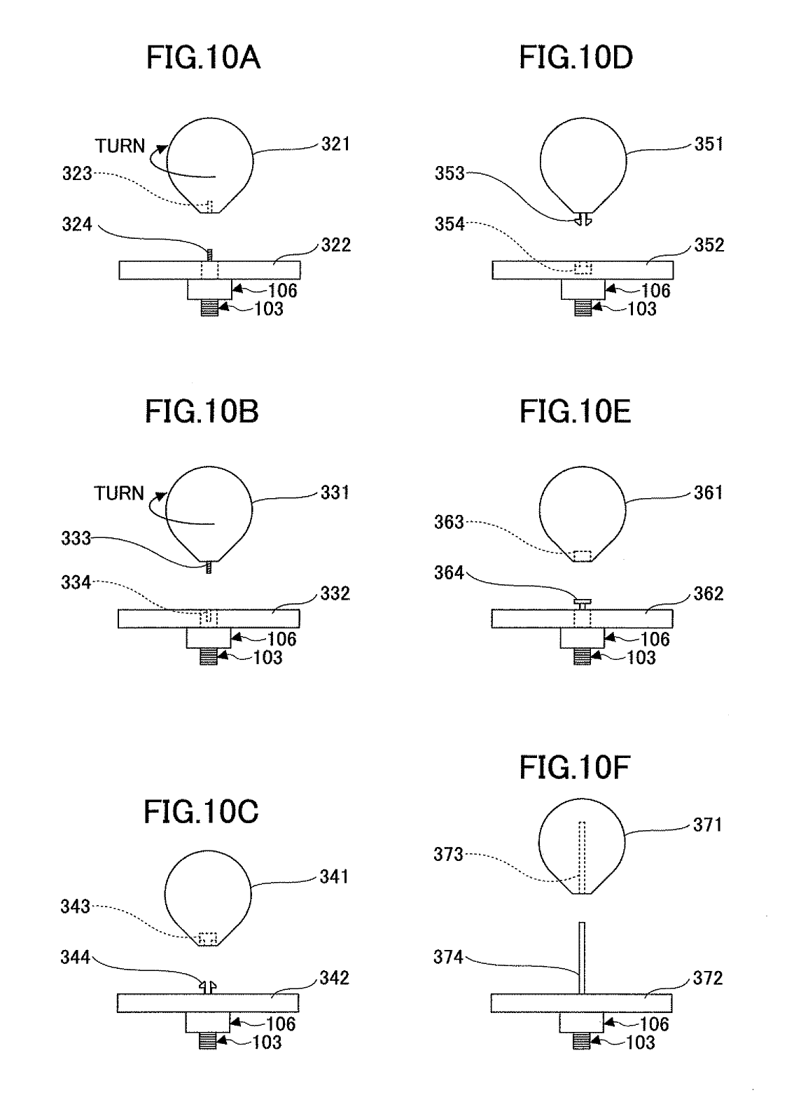

Next, a description is given, with reference to FIGS. 10A through 10F, of methods of mechanically attaching a teardrop-shaped element to a metal plate.

FIG. 10A illustrates a configuration where, the same as in the first embodiment, an external thread part 324 is formed on a metal plate 322 and an internal thread part 323 is formed at the end of the cone-shaped part of a teardrop-shaped element 321, so that the teardrop-shaped element 321 is screwed to the metal plate 322 with the external thread part 324 and the internal thread part 323.

FIG. 10B illustrates a configuration where an internal thread part 334 is formed in a metal plate 332 (for example, in the inside metal part 106A [FIG. 4] of the connector 106 attached to the metal plate 332) and an external thread part 333 is formed at the end of the cone-shaped part of a teardrop-shaped element 331, so that the teardrop-shaped element 331 is screwed to the metal plate 332 with the external thread part 333 and the internal thread part 334.

FIG. 10C illustrates a configuration where a compressible extending fitting part 344 is formed on a metal plate 342 (for example, on the inside metal part 106A [FIG. 4] of the connector 106 attached to the metal plate 342) and a recessed fitting part 343 corresponding to the compressible extending fitting part 344 is formed at the end of the cone-shaped part of a teardrop-shaped element 341, so that the compressible extending fitting part 344 and the recessed fitting part 343 are fit to each other.

FIG. 10D illustrates a configuration where a compressible extending fitting part 353 is formed at the end of the cone-shaped part of a teardrop-shaped element 351 and a recessed fitting part 354 corresponding to the compressible extending fitting part 353 is formed in a metal plate 352 (for example, in the inside metal part 106A [FIG. 4] of the connector 106 attached to the metal plate 352), so that the compressible extending fitting part 353 and the recessed fitting part 354 are fit to each other.

FIG. 10E illustrates a configuration where a projecting part 364 is formed on a metal plate 362 (for example, on the inside metal part 106A [FIG. 4] of the connector 106 attached to the metal plate 362) and a hole part 363 corresponding to the projecting part 364 is formed at the end of the cone-shaped part of a teardrop-shaped element 361, so that the projecting part 364 is placed in and bonded to the hole part 363 with an electrically conductive adhesive agent.

FIG. 10F illustrates a configuration where an elongated rod-shaped part 374 is formed on a metal plate 372 (for example, on the inside metal part 106A [FIG. 4] of the connector 106 attached to the metal plate 372) and a hole part 373 corresponding to the rod-shaped part 374 is formed in a teardrop-shaped element 371 to extend inward from the end of its cone-shaped part, so that the rod-shaped part 374 is fit into and connected to the hole part 373.

The teardrop-shaped element and the metal plate may be connected by the above-described methods. If the enclosure is formed of a metal material, part of the enclosure may replace the metal plate and be used as a ground plate.

According to the above-described methods illustrated in FIGS. 10A through 10D and 10F, the metal plate and the teardrop-shaped element are easily attachable to and detachable (removable) from each other. Accordingly, it is possible to change the teardrop-shaped element to an optimum one with ease.

Thus, according to an aspect of the present invention, an antenna device is provided that can transmit and/or receive radio waves with stability at low cost and whose feeding body is replaceable (changeable) in accordance with an operating frequency band (or a frequency band to be used).

All examples and conditional language recited herein are intended for pedagogical purposes to aid the reader in understanding the present invention and the concepts contributed by the inventors to furthering the art, and are to be construed as being without limitation to such specifically recited examples and conditions, nor does the organization of such examples in the specification relate to a showing of the superiority or inferiority of the present invention. Although the embodiments of the present invention have been described in detail, it should be understood that various changes, substitutions, and alterations could be made hereto without departing from the spirit and scope of the present invention.

What is claimed is:

1. An antenna device, comprising:
a teardrop-shaped element including a cone-shaped part and a spherical surface part geometrically combined so that the spherical surface part is in contact with the cone-shaped part on a bottom-surface side thereof;
a ground plate opposed to an apex of the cone-shaped part of the teardrop-shaped element; and
a coaxial line having an inside conductor thereof connected to the apex of the cone-shaped part of the teardrop-shaped element and having an outside conductor thereof connected to the ground plate,
wherein the ground plate defines a surface of a metal enclosure of a device to be connected to the antenna device, the device having at least one of a transmission function and a reception function.

2. The antenna device as claimed in claim 1, wherein the ground plate is grounded.

3. The antenna device as claimed in claim 1, further comprising:
a resin cover configured to entirely cover the teardrop-shaped element, the resin cover being formed of a resin material.

4. The antenna device as claimed in claim 1, wherein the teardrop-shaped element is embedded entirely in a resin material.

5. The antenna device as claimed in claim 4, wherein the resin material is transparent.

6. The antenna device as claimed in claim 1, wherein the teardrop-shaped element is detachably attached to the ground plate.

7. The antenna device as claimed in claim 6, wherein the teardrop-shaped element is replaceable in accordance with a frequency band to be used.

8. The antenna device as claimed in claim 7, further comprising:
an external thread part provided to a first one of the teardrop-shaped element and the ground plate; and
an internal thread part provided to a second one of the teardrop-shaped element and the ground plate,
wherein the teardrop-shaped element is detachably attached to the ground plate through an engagement of the external thread part and the internal thread part.

9. The antenna device as claimed in claim 7, further comprising:
an extending fitting part provided to a first one of the teardrop-shaped element and the ground plate; and
a recessed fitting part provided to a second one of the teardrop-shaped element and the ground plate,
wherein the teardrop-shaped element is detachably attached to the ground plate through fitting of the extending fitting part into the recessed fitting part.

10. The antenna device as claimed in claim 1, wherein the teardrop-shaped element is attached to the ground plate with an electrically conductive adhesive agent.

11. An antenna device, comprising:
a teardrop-shaped element including a cone-shaped part and a spherical surface part geometrically combined so that the spherical surface part is in contact with the cone-shaped part on a bottom-surface side thereof;
a ground plate opposed to an apex of the cone-shaped part of the teardrop-shaped element; and
a coaxial line having an inside conductor thereof connected to the apex of the cone-shaped part of the teardrop-shaped element and having an outside conductor thereof connected to the ground plate,
wherein the ground plate is provided on one of an exterior surface and an interior surface of a metal enclosure of a device to be connected to the antenna device, the device having at least one of a transmission function and a reception function.

12. The antenna device as claimed in claim 11, wherein the ground plate is grounded.

13. The antenna device as claimed in claim 11, further comprising:
a resin cover configured to entirely cover the teardrop-shaped element, the resin cover being formed of a resin material.

14. The antenna device as claimed in claim 11, wherein the teardrop-shaped element is embedded entirely in a resin material.

15. The antenna device as claimed in claim 14, wherein the resin material is transparent.

16. The antenna device as claimed in claim 11, wherein the teardrop-shaped element is detachably attached to the ground plate.

17. The antenna device as claimed in claim 16, wherein the teardrop-shaped element is replaceable in accordance with a frequency band to be used.

18. The antenna device as claimed in claim 17, further comprising:
an external thread part provided to a first one of the teardrop-shaped element and the ground plate; and
an internal thread part provided to a second one of the teardrop-shaped element and the ground plate,
wherein the teardrop-shaped element is detachably attached to the ground plate through an engagement of the external thread part and the internal thread part.

19. The antenna device as claimed in claim 17, further comprising:
an extending fitting part provided to a first one of the teardrop-shaped element and the ground plate; and
a recessed fitting part provided to a second one of the teardrop-shaped element and the ground plate,
wherein the teardrop-shaped element is detachably attached to the ground plate through fitting of the extending fitting part into the recessed fitting part.

20. The antenna device as claimed in claim 11, wherein the teardrop-shaped element is attached to the ground plate with an electrically conductive adhesive agent.
